(19) United States
(12) Patent Application Publication
(10) Pub. No.: US 2018/0357626 A1
(43) Pub. Date: Dec. 13, 2018

(54) Method and system for controlling fuel dispenser

(71) Applicant: Miguel S. Giacaman, Henderson, NV (US)

(72) Inventor: Miguel S. Giacaman, Henderson, NV (US)

(21) Appl. No.: 16/104,905

(22) Filed: Aug. 18, 2018

Related U.S. Application Data
(63) Continuation-in-part of application No. 10/491,325, filed on Jul. 27, 2004, now Pat. No. 10,077,769.
Application No. 10/491,325 is a continuation-in-part of application No. 10/515,776, filed on Nov. 24, 2004.
Application No. 10/515,776 is a continuation-in-part of application No. 16/039,318, filed on Jul. 18, 2018.
(60) Provisional application No. 62/548,346, filed on Aug. 21, 2017.
(60) Provisional application No. 62/547,104, filed on Aug. 18, 2017.

(51) Int. Cl. G06Q 20/20; G06Q 50/06

(52) U.S. Cl. CPC G06Q 20/202; G07F 13/06; G06Q 50/06

(57) ABSTRACT

A fast data transfer fuel dispenser control system and method comprising a main control unit connected to a plurality of control devices that each one communicates with at least one fuel dispenser independently of said main control unit, allowing simultaneous and continuous communication with the fuel dispensers in a station. That allows capturing and displaying real time information coming from a plurality of fuel dispensers while maintaining close synchronization with their respective fuel metering systems.

### CROSS-REFERENCE TO RELATED APPLICATION

The present application claim priority of U.S. Provisional Application No. 62/547,104 filed on Aug. 18, 2017 and U.S. Provisional Application No. 62/548346 filed on Aug. 21, 2017, and is a Continuation In-Part application of the U.S. Nonprovisional application Ser. No. 10/491,325 filed on Jul. 27, 2004, Ser. No. 16/039,318 filed on Jul. 18, 2018, and Ser. No. 10/515776 filed on Nov. 24, 2004 each in their entirety incorporated herein by reference.

### BACKGROUND

1. Field of the Invention

The present invention relates to a fuel dispenser control system to be used by fuel management systems at fuel service stations.

2. Background of the Invention

Fuel service stations, also known as gas stations use a fuel management system that, by means of a fuel dispenser control system, communicate with and control fuel dispensers located on a station. The fuel management system is usually comprised of at least one Point of Sales (POS), with the appropriate software that runs on the POS computer, and a dispenser control system. The POS provides (1) a user interface to oversee the fuel dispenser activity, usually via a computer screen, LCD display or on older systems a character display, and (2) data management like credit authorization, electronic charges, ticketing, price and inventory management and database administration.

The POS also allows visualization of the fueling operations in real time, as the vehicles are filled up, by means of said dispenser control system to obtain real time information such as amount and volume been dispensed, status such as nozzle in and/or out, type of selected fuel, and any other relevant information on a current fueling operation. In addition to the real time information the POS uses said dispenser control system to obtain the final sales information, which includes the final amount, volume and price of fuel delivered into the vehicle once the fueling operation has concluded, which is usually indicated by the return of the nozzle into the nozzle holder on the dispenser.

The dispenser control system is the first line of communication with the fuel dispensers and controls all fueling activities of the dispenser necessary to carry out fuel dispensing functionalities. It issues commands to the fuel dispensers over the communication line associated to each of the fuel dispensers in a station by means of a brand specific electrical communications interface and a proprietary messaging protocol specified by the manufacturer of the fuel dispensers. This communication allows the dispenser control system to control the dispensers and send action commands to modify the fuel price per unit of volume, preset of maximum amount or volume of fuel to be dispensed, authorize to dispense fuel, etc. The fuel dispensers then send data back to the dispenser control system that may include fueling point number, dispenser status and dispensed fuel volume, amount and other values related to the fueling operation.

This bidirectional data transfer allows it to get the sale progress information as it is presented on the fuel dispenser screen in the form of real-time fuel flow information and final sales amount and volume. This information is captured by the dispenser control system and is transmitted to the fuel management system.

A problem exists in a traditional fuel dispenser control systems since they can only communicate with one fuel dispenser at a time. This slows the communications with each dispenser activity as multiple fueling operations occur simultaneously.

The communication topologies used by prior art fuel dispenser control systems are based on a computerized device that uses one serial port connected to one or more dispenser brand specific electrical interfaces to each of the fuel dispensers. And by means of the dispenser proprietary protocol messaging they communicate with all the fuel dispensers in a station using a distributed bus topology or a star topology. Both topologies allow communication between a dispenser control system and only one of the fuel dispensers in a station at a particular time. With either of these topologies, the communication is usually sequenced in a numeric progression of fueling point identification numbers. Data transfer speed achieved with these topologies is sufficient when the communication needs are limited to fueling authorization, final sales data retrieval and general dispenser configuration or operation, like changing fuel price and obtaining volume and amount totalizers.

One limitation of these topologies is that obtaining real time information while the fuel is being dispensed would be limited to just one fueling point at a time. Otherwise, the refresh rate would be too slow to become a useful indication of the dispenser fueling activity. This limitation to the topologies of the prior art becomes more evident when real time data is requested from several or from all the fuel dispensers at the same time and get worsen when an additional action or data is requested, like special discounted price for just one sale, dispenser totalizer request before and after each sale, price verification before authorizing the dispenser, etc.

Another significant limitation is that if the real time information is to be broadcasted to fuel dispensers secondary displays to show the fuel dispensing operation activity would not be possible with the prior art topologies if maintaining close synchronization with the fuel meters of the dispensers is desired.

Therefore, if real time data relating to all fueling transactions and operations going on a fuel service station when several or all the fuel dispensers are active at a particular time, then an apparatus, system and method to communicate and control all the fuel dispensers simultaneously and continuously is needed.

### SUMMARY OF THE INVENTION

### Definitions

The term “dispenser” means a dispensing equipment used to deliver fuel to vehicles at fuel service stations, also known as fuel pump. A fuel dispenser is divided into two main parts; a lower part, containing the electromechanical elements including the meters, pulsars and valves to control the fuel flow; and an upper part containing a pump computer and associated electrical components to compute the signals from the fuel meter, drive the primary displays, communicate to an indoor sales system and controls the electromechanical elements on the lower part. Both parts are separated by a safety divider called “vapors barrier.”

The term “pump computer” means the electronic computer system inside a fuel dispenser. It locates on the upper part of a dispenser inside an enclosure separated from the lower part of the dispenser by a safety barrier called “vapors barrier” that prevents fuel vapors to enter the electric space on top. The pump computer computes the signals provided by the electromechanical fuel metering system, calculates at least the amount and volume dispensed and shows these values along with PPU and product selected on the primary display. Additionally, the pump computer control most aspect of the operation of the dispenser, including but not limited to the fuel valves and sensing the nozzle activation. One important feature of the pump computer is to provide with a data communications line to send information in and out of the dispenser. This data communications line can connect with internal or external fuel dispenser control equipment or system.

The term “primary display” means the conventional display usually on the upper part of a dispenser and mechanically integrated inside the dispenser enclosure and centered or proximately centered to the front of the dispenser's enclosure and facing to the person operating the dispenser. It is one or more per dispenser and its location is optimized to be easily visualized by the person manipulating the dispenser, either a driver or a passenger on a self-service station or an attendant on a full service station.

The term “secondary display,” in which “secondary” may be considered a generic term for any display in addition to the primary display, means a fuel dispenser display located and positioned to allow the vehicle driver to monitor the fueling operation being performed by an attendant or a passenger while the driver is seated on the driver's seat inside the vehicle that is being fueled up.

The term “Real Time Information (RTI)” means data provided by the dispenser, either by means of an electronic display or by means of a data communications line to an external control system or device. RTI indicates the amount of money and/or volume of fuel dispensed while the fuel is being delivered to a vehicle. This information may also indicate the status of the fueling operation, including handle up (or nozzle out) handle down (or nozzle in), fuel product selected and price per unit of volume (aka PPU). This information is normally visualized by means of a primary display on the upper section of a fuel dispenser and it is automatically and continuously being displayed during the fueling operation. And, once the fueling operation has concluded, the Real Time Information (RTI) should be equal to the amount and volume indicated by the End of Sale values (EOS). For comparison, RTI is different than information contained in a database with the sales than occurred within a period of time, like a work shift or one day, which reflects fueling operations that have concluded, hence, it's not real time information.

The term “Close Synchronization” means communication with the dispenser's metering system or pump computer to allow the secondary display to show the amount and volume dispensed simultaneously with the actual values, meaning, with less than one second delay in reference to the actual volume and money being delivered to the vehicle. Less than one second would be the maximum time delay and less than one quarter of second desirable. This delay should be within these maximum limits even with all the fueling points at the fuel service station are active and fueling vehicles up.

The term “Dedicated Control Device” means a dedicated pump controller that is a dispenser controller device installed on a fuel pump, proximate and in connection with each fuel pump. The device is capable of functioning as a pump controller dedicated solely to the pump for which it is installed. This dedicated pump controller contains a microcomputer with a (brand-specific) pump communications interface and optionally a communications interface with a Main Control Unit either Local or Complete, which is non-dedicated and has control over two or more pumps at the gas station. A Dedicated Control Device may function as a slave of the Main Control Unit and, in case of a failure of the communication with the Main Control Unit it may change into master mode functioning autonomously to control the fuel dispenser on its own.

The term “Dedicated Communication Channel” means a communication link with the fuel dispenser that allows passing along a controlling message protocol issued by the master control unit or fuel dispenser controller.

The term “Local and Remote” means the purpose of this patent, Local is when the device or equipment is located in the office and remote when it is located in one of the gas station islands. For the purpose of this patent, a fuel service station is divided into two locations, the office and the site. The office is usually a building structure for the administration of the station and can optionally be a convenience store or any associated business. Any structure were the electric panels, control equipment, power generators and a plurality of support equipment for the operation of the station is located are considered part of the office. The site is where the fueling operations are conducted; it includes the island and the pavement for the vehicles. The islands are where the fuel dispensers are located and also support the roof. The fuel dispensers electric and data wiring reach the island via underground conduits connecting the office with the island, hence, a Remote device or equipment would be connected to the wiring emerging from the island end of said underground conduits and a Local device or equipment would be connected to the wiring emerging from the office end of said underground conduits.

The term “Low Data Rate” means at a data rate, e.g. bits per second, that is compatible with communications directly with the fuel dispenser's Pump Computer.

The term “High Data Rate” means the capacity of carrying the communication data strings to and from a plurality of fuel dispenser simultaneously, e.g. in real time. The preferred method to accommodate multiple data strings is to increase the bit per second, also called Baud rate, for example, if the communication with the dispensers is at a low data rate of 9600 bauds, then the communication on the high data rate line would be at 115,200 Bauds. Other methods could be used in increase the data capacity, for example, compressing the data or compacting the data string to fill up time gaps between data strings.

The term “Main Control Unit” means a unit that connects internally or externally to a plurality of dedicated control devices and it also connects with a Fuel Management System, which may include a POS or any other type of electronic fuel management equipment.

The term “Dispenser Control System” means an electronic equipment capable of sending and receiving controlling messages to one or more fuel dispensers using protocol specified by the manufacturer of the fuel dispenser.

The term “Simultaneously” means that all the dedicated control devices communicate with their associated fuel dispensers at the same moment, e.g. if there are 8 fuel dispensers connected to 8 dedicated communication channels all 8 fuel dispensers can receive and controlling messages protocol and send data back at any time without interfering with one another.

The term “Continuously” means that a dedicated communication channels or dedicated control devices can acquire information in advance and keep it ready to be passed along to the controller or master control unit immediately on request, e.g. if the main control unit is gathering fuel dispenser information from one of the dedicated control devices, each other dedicated control devices can request information from the fuel dispenser before it is requested by the main control unit in order to speed up the data collection.

The term “Internal Communication Protocol (ICP)” means any protocol used to communicate the Main Control Unit with the plurality of Dedicated Control Devices. It could be a proprietary protocol or any standard protocol like ISFS or the same dispenser's proprietary protocol. The condition for any protocol to become an ICP is to modify it to be compatible with a High Data Rate digital line or wireless channel.

The present invention provides a fuel dispenser control system, apparatus and method using a fuel dispenser Control System comprised of a Main Control Unit furnished with a plurality of Dedicated Control Devices or Dedicated Communication Channels one per fuel dispenser to continuously and simultaneously transfer data to and from fuel dispensers. This data includes but is not be limited to Real Time Information to be communicated to a POS or other equipment or devices via at least one digital communication line.

Each Dedicated Control Device is comprised of a microcomputer to process and buffer data that are sent or received to or from its associated fuel dispenser. The Dedicated Control Device controls the associated fuel dispenser directly and translates a Main Control Unit Internal Communication Protocol (ICP) to the proprietary protocol of the associated fuel dispenser. This information including the real time and status from the fuel dispensers is collected by the Main Control Unit and broadcasted to a plurality of electronic devices, like secondary displays that may be installed on or proximate to each fuel dispenser and would be in addition to the primary displays that are part of the fuel dispensers. These secondary displays are preferred to be of a large size and located in a way that can facilitate to be seen by the driver while seated inside of his vehicle.

The Main Control Unit interoperates with the Dedicated Control Devices to deliver commands and receive transaction data and status to and from the fuel dispensers in a simultaneous way, contrary to sequentially as in prior art.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates the Fuel Management System connected to a prior art fuel Dispenser Control System.

FIG. 2 illustrates the Fuel Management System connected to another prior art fuel Dispenser Control System.

FIG. 3 illustrates a Dispenser Control System having a main control unit connected via a serial port and the interfaces to the Dedicated Control Devices in a Remote position in accordance with the embodiment of the present invention.

FIG. 4 illustrates the Dispenser Control System connected via a serial port to the Dedicated Control Devices in a Local position in accordance with the embodiment of the present invention.

FIG. 5 illustrates the Dispenser Control System having a computer unit using a main control process to communicate simultaneously and continuously with the fuel dispensers via Dispenser Control Process and associated interfaces.

FIG. 6 illustrates the Dispenser Control System having a main control unit connected to a serial port, an interface, and a data line selector or D-Box to the Dedicated Control Devices in a remote position in accordance with the embodiment of the present invention.

FIG. 7 illustrates the Dispenser Control System having a main control unit connected to the serial port and a radio frequency channel to communicate with to the Dedicated Control Devices in a remote position in accordance with the embodiment of the present invention.

### DETAILED DESCRIPTION OF THE DISCLOSURE

The embodiments set forth below represent the necessary information to enable those skilled in the art to practice the invention and illustrate the bet mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

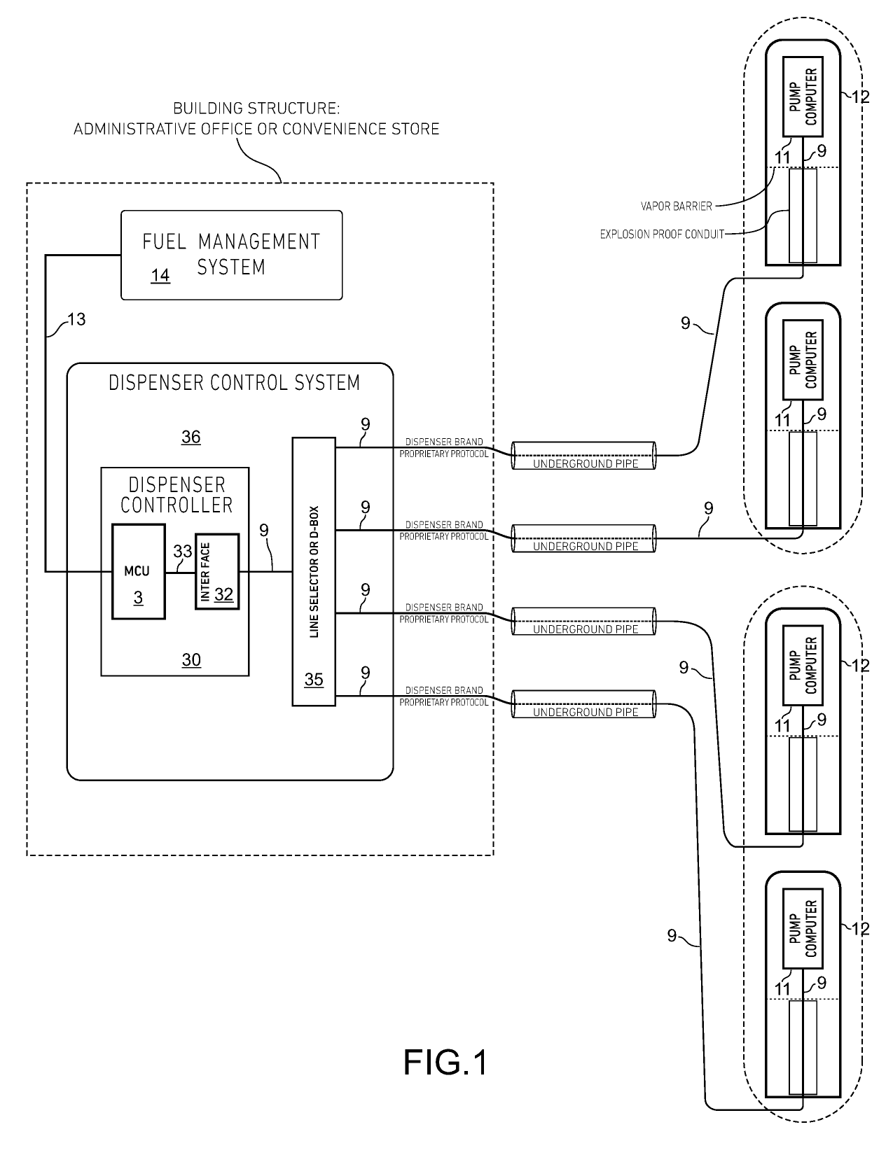

FIG. 1 is a conventional fuel management system 14 connected to a prior art fuel dispenser control system 36 having a dispenser controller 30 and a data line connector or D-box 35. A computer or microcomputer MCU 31 connected to a compatible electrical dispenser 32 via a serial data line 33 to communicate via a Low Data Rate line 9 and through a data Line Selector or D-Box 35 with a plurality of Pump Computers 11 inside the fuel dispensers 12 one at a time in a sequential manner. This prior art has multiple communication lines but it cannot address more the one fuel pump at the same time.

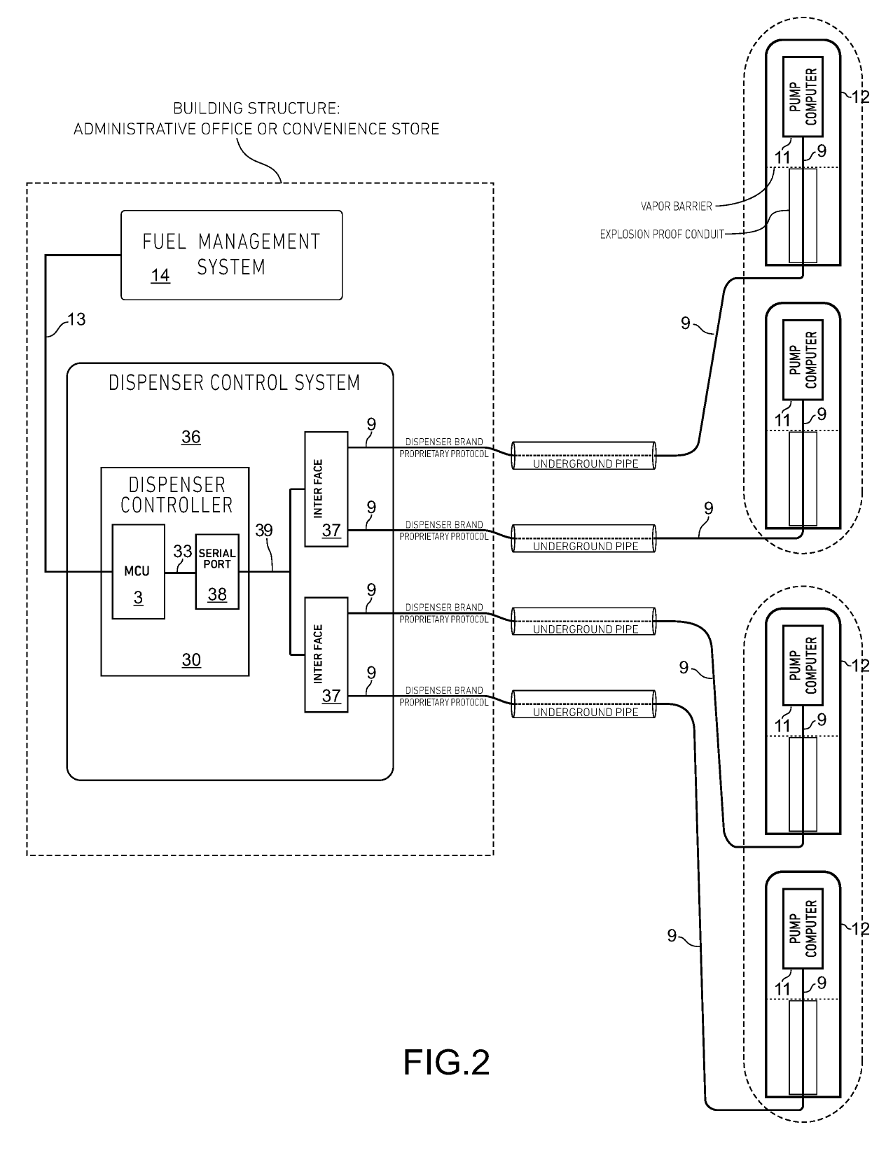

FIG. 2 shows a conventional Fuel Management System 14 connected to another prior art fuel Dispenser Control System 36 comprised of a Dispenser Controller 30 connected via a Low Data Rate line 39 to a plurality of Interfaces 37 compatible with the fuel dispensers 12 which a connected via a Low Data Rate line 9 to a plurality of fuel Dispensers 12. The Dispenser Controller 30 is comprised of a computer or Microcomputer Unit 3 connected via a Low Data Rate line 33 to a serial port 38 to communicate via a data line 9 and through a data Line Selector or D-Box 35 with a plurality of Pump Computers 11 inside the fuel dispensers 12. Even though, this prior art has multiple communication interfaces connected to the fuel dispensers, they cannot communicate with their respective fuel dispensers in a simultaneously and continuous manner, because the computer or Microcomputer Unit 3 communicates with all the dispenser 12 via one Low Data Rate line 33, hence, only one dispenser can be addressed at a time, to be followed to the others in a sequential manner.

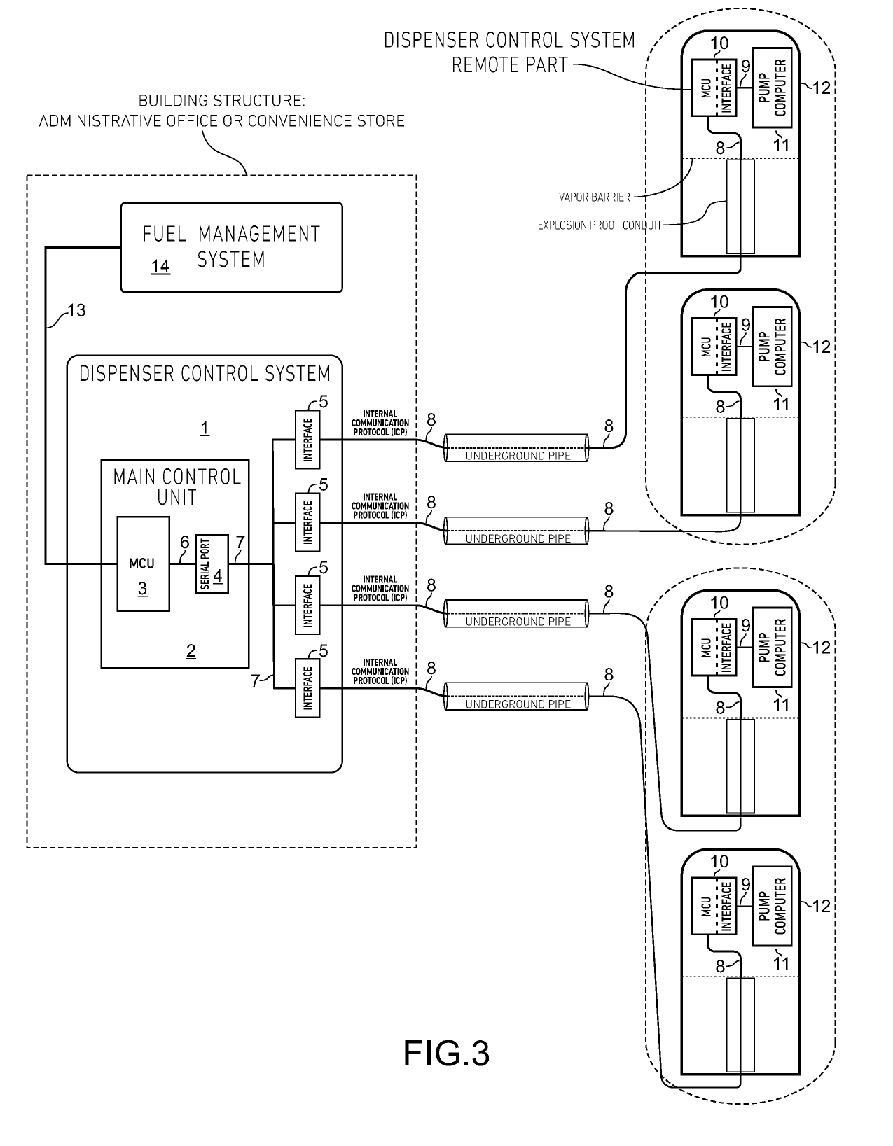

FIG. 3 depicts a Dispenser Control System having a Main Control Unit 2 in a Local position and the Dedicated Control Devices 10 in a remote position. The Main Control Unit includes a Microcomputer Unit 3 connected to a serial port 4 via a data line 6, and data lines 7 connected to the electrical interfaces 5 each one suitable for communicating with one of the Dedicated Control Devices 10 via one of the data lines 8. Each Dedicated Control Device 10 includes a computer unit and an interface for communicating with the Pump Computer 11 inside the fuel dispenser 12. This interface is compatible with the Pump Computer 11 that is connected to, via a wire data line 9. The communication between the Main Control Unit 2 and the plurality of Dedicated Control Devices 10 can be done at a much higher data rate than the Dedicated Control Devices 10 to their associated fuel dispensers 12. This point to point topology and simultaneous communication capability increases the data throuput of the Dispenser Control System up to about ten times faster than any existing prior art. The communication between each of the Dedicated Dispenser Controllers 10 and the fuel dispensers 12 is in accordance with the fuel dispenser manufacturer specifications in terms of the electrical interface and proprietary messaging protocol.

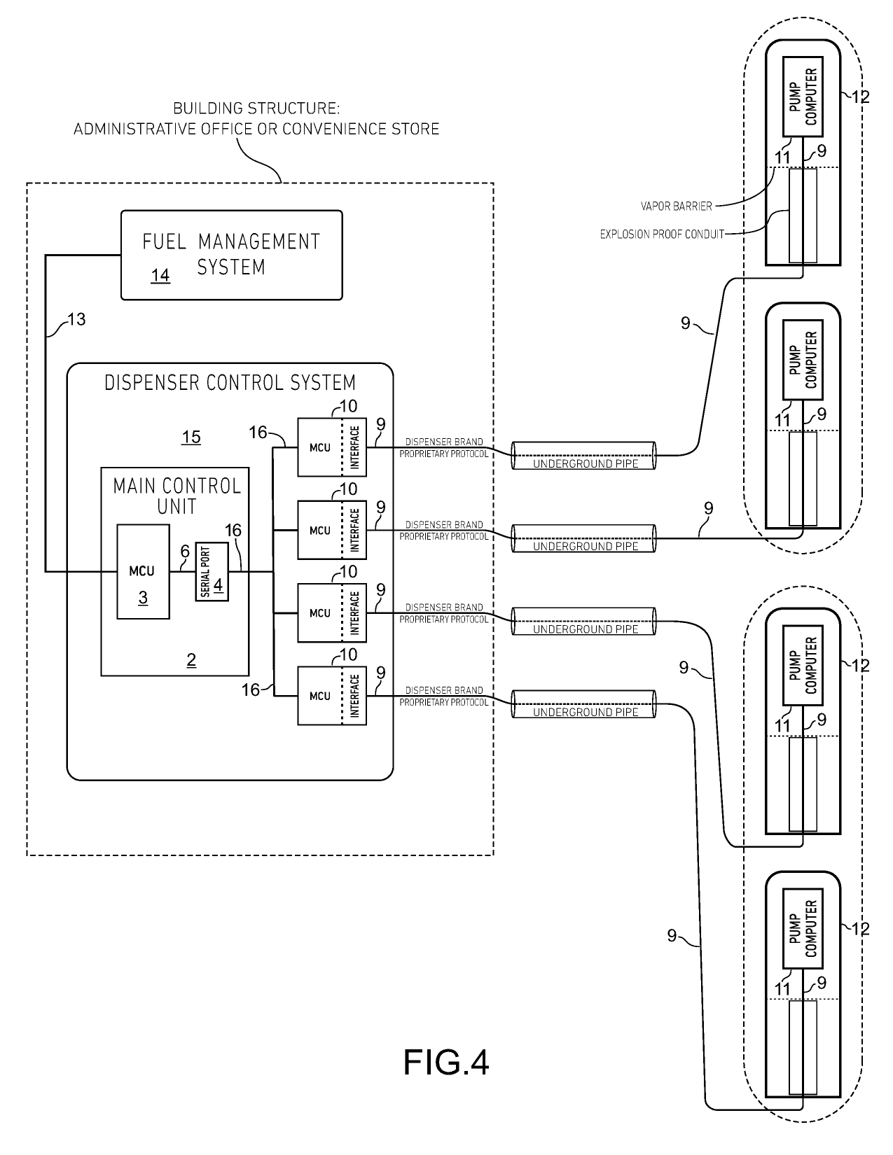

FIG. 4 shows a Dispenser Control System 15 comprising a Main Control Unit 2 and a computer or Microcomputer 3 connected to a serial port 4 via a data line 6. The serial port 4 connects via the data lines 16 to the Dedicated Control Units 10. Each Dedicated Control Unit 10 has a compatible electric interface for communicating with fuel dispensers 12 via the data lines 9 in a point to point topology and with a firmware or software implementation. The point to point topology allows simultaneous and continuous data transfer to and from the fuel dispensers 12. The Main Control Unit 2 and the Dedicated Control Units 10 can be Local position and be configured as a single piece of equipment 15 or as a single electronic board.

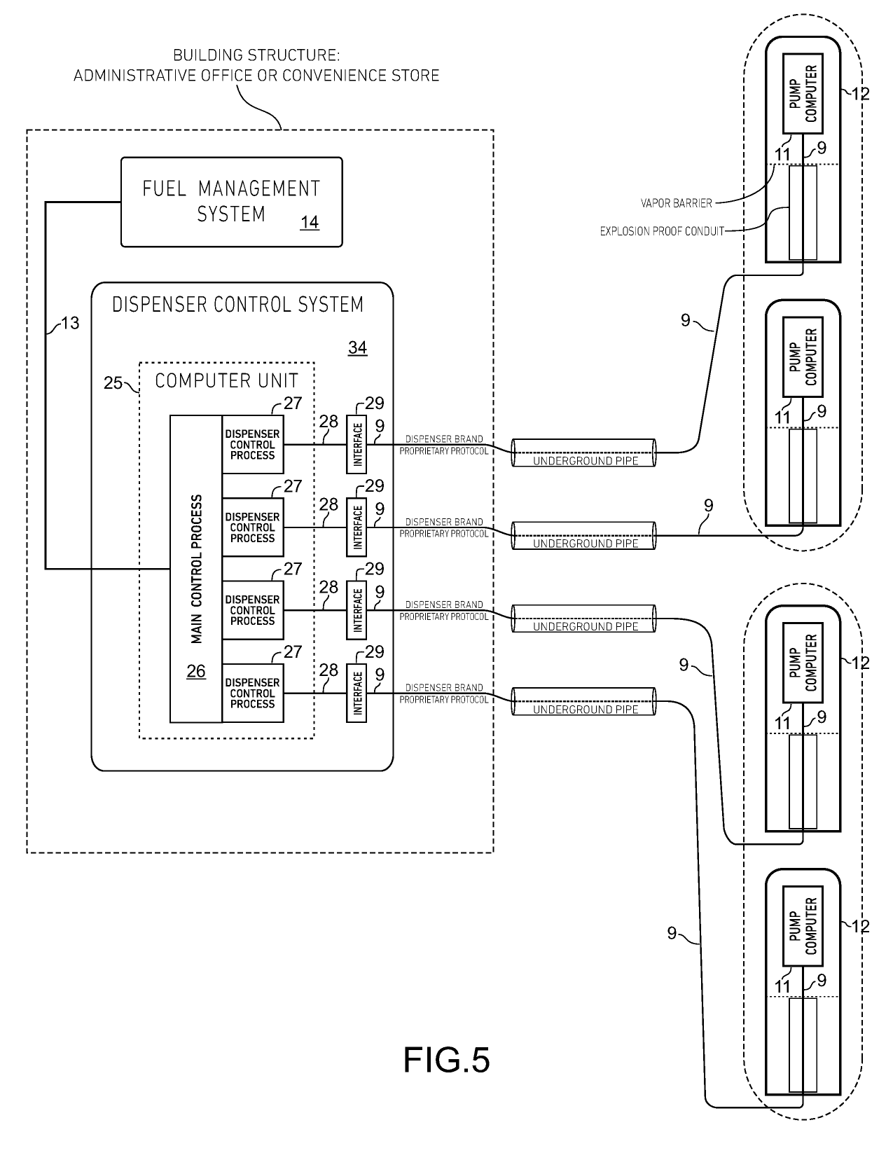

In FIG. 5, an alternative means for simultaneous and continuous communication with the fuel dispensers 12 is to implement the Dispenser Control Units 10 as Dispenser Control Processes 27 that are simultaneous execution of software processes in a computer or microcomputer unit 25. The simultaneous software execution can be achieved by multitasking, multithreading, multiprogramming or multiprocessing software execution technologies. The computer unit 25 includes one serial data channel 28 per Dedicated Control Process 27. Each serial data channel is connected via an interface 29 to a dispenser Pump Computer 11 via a Low Data Rate line 9. The communication between the Main Control Unit 2 and the plurality of Dispenser Control Process 27 is via a High Data Rate link. Additionally, the Main Control Unit 2 can also be implemented as an additional simultaneous execution software processes in the form of a Main Control Process 26 in the same computer unit 25 that is running the plurality of Dispenser Control Processes 27. In that case, the communication between the Main Control Process 26 and the plurality of Dispenser Control Processes 27 are via a High Data Rate link, which can be internal in the single computer unit 25.

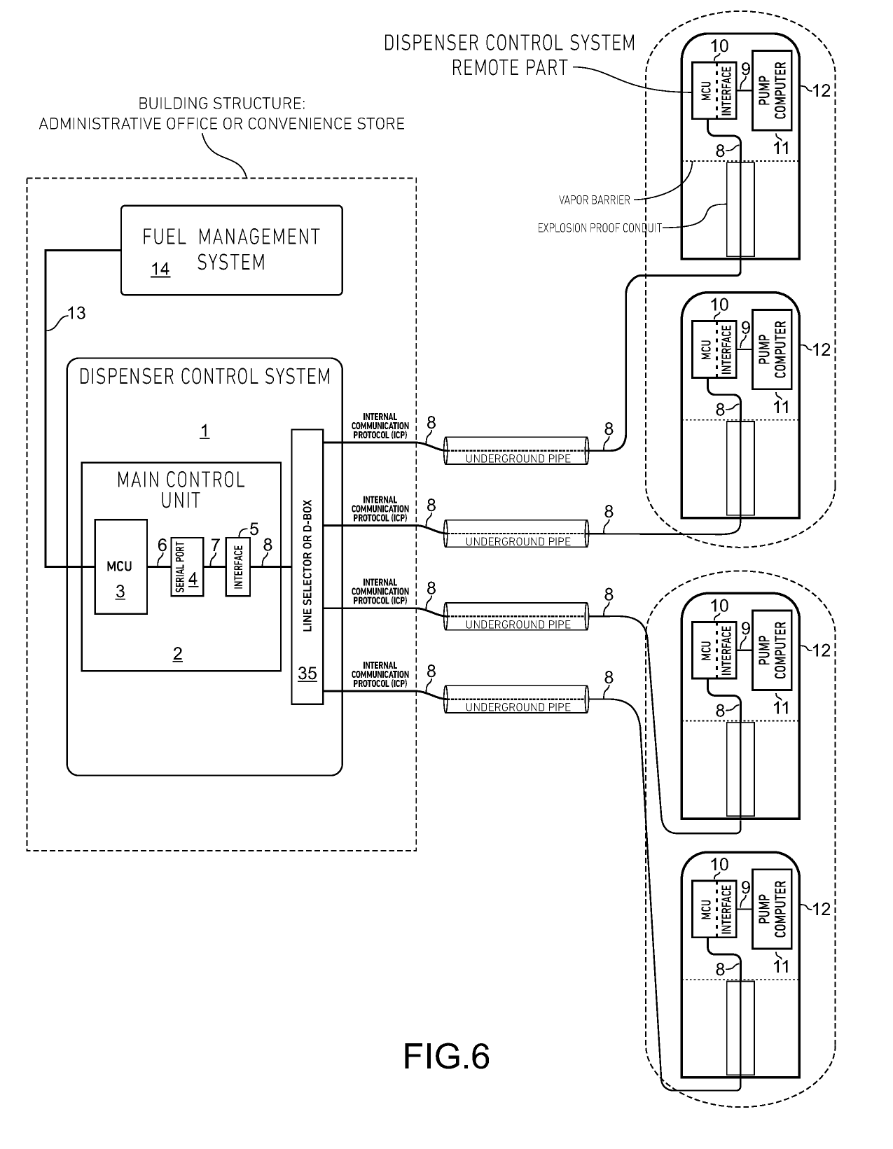

FIG. 6 demonstrates an alternative means of achieving simultaneous and continuous communication with the fuel dispensers 12. The Main Control Unit 2 connected to a serial port 4 via a data line 6, to an interface 5 via a data line 7, and to a data Line Selector or D-Box 35 via a data line 8 connected that configures a bus topology to connect with the Dedicated Control Devices 10.

In FIGS. 3,4,5,6 and 7, the data lines 6, 7, 8 and 16 are High Data Rate type, and data lines 9 and 28 are Low Data Rate type

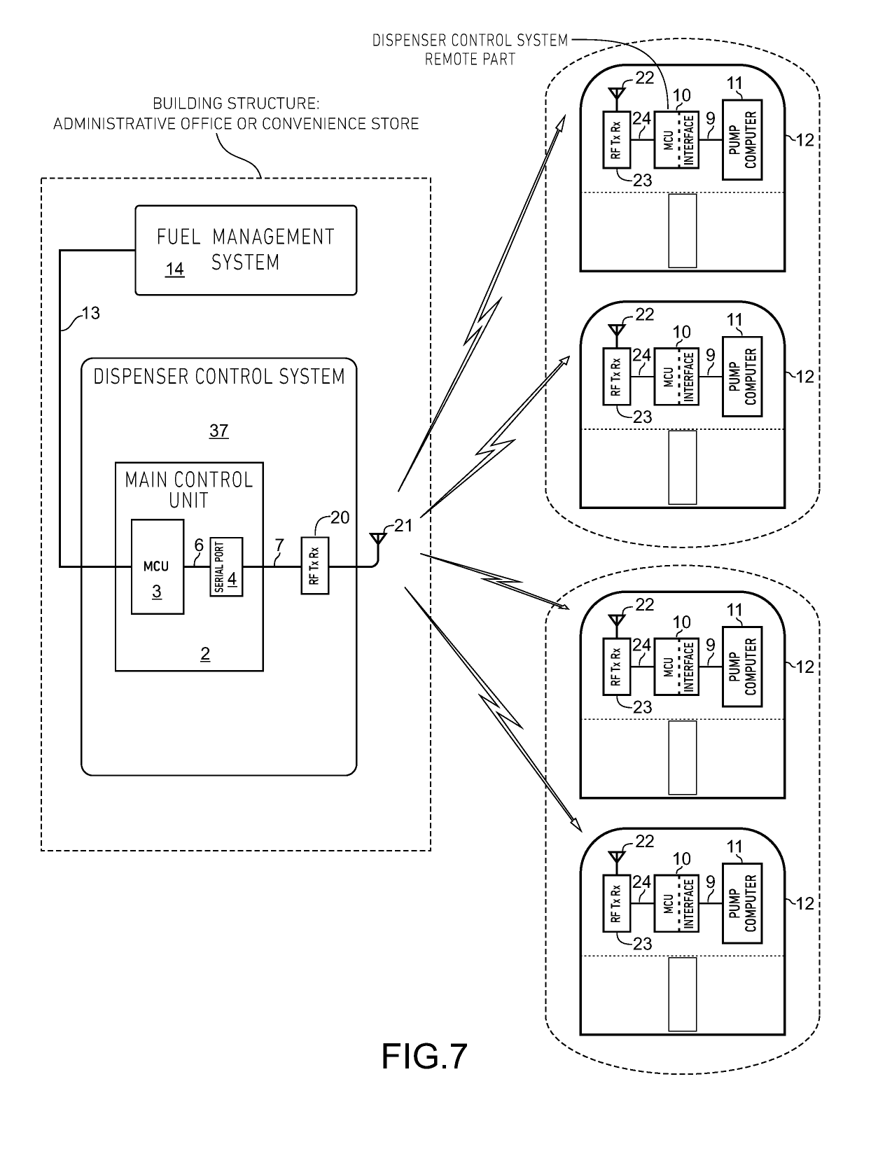

FIG. 7 shows the Main Control Unit 2 connected to a serial port 4 via a data line 6. The serial port 4 connects to the radio frequency transceiver 20 via a data line 7. The radio frequency transceiver 20 connects wirelessly with the remote transceivers via antennas 21 and 22. Each remote transceiver connects to a Dedicated Control Unit 10 via a data link 24. Each Dedicated Control Units 10 uses an Internal Communication Protocol (ICP) to communicate wirelessly with the Main Control Unit, and uses the dispenser proprietary protocol to communicate with the Pump Computer 11 via a data line 9 and to control its associated fuel dispenser 12.

As various modifications could be made to the exemplary embodiments, as described above with reference to the corresponding illustrations, without departing from the scope of the invention, it is intended that all matter contained in the foregoing description and shown in the accompanying examples shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A fuel dispenser control system for communicating with a fuel management system and a plurality of fuel dispensers comprising
a main control unit including at least one computerized device communicatively linked to said fuel management system at high data rate with a plurality of fuel dispenser control devices, wherein
each of said plurality of fuel dispenser control devices including at least one computer unit communicatively linked with at least one pump computer via a low data rate line wherein said at least one pump computer locates inside one of said plurality of fuel dispenser, wherein
said plurality of dispenser control devices communicate simultaneously with pump computers, wherein data collected from said pump computers are in close synchronization with a fuel meter of each of said plurality of fuel dispensers, wherein
communication of said plurality of fuel dispenser control devices with said pump computers is independent from said main control unit, and wherein
communication of said plurality of fuel dispenser control devices with said pump computers is performed continuously.

2. The fuel dispenser control system of claim 1, wherein said main control unit is communicatively linked via a plurality of high data rate lines to said plurality of fuel dispenser control devices, wherein each one of said high data rate lines is communicatively linked with one of said plurality of fuel dispenser control devices.

3. The fuel dispenser control system of claim 1, wherein said main control unit communicatively links to said plurality of fuel dispenser control devices via a high data rate wireless channel, and wherein said plurality of fuel dispenser control devices communicatively link to said main control unit via a high data rate wireless channel.

4. The fuel dispenser control system of claim 1, wherein said main control unit locates in local position in the fuel service station, and said plurality of fuel dispenser control devices locate in remote position in the fuel service station.

5. The fuel dispenser control system of claim 1, wherein said main control unit and said plurality of fuel dispenser control devices locate in local position in the fuel service station.

6. The fuel dispenser control system of claim 1, wherein said main control unit and said plurality of fuel dispenser control devices locate in remote position in the fuel service station.

7. The fuel dispenser control system of claim 1, wherein functionality of each of said plurality of fuel dispenser control devices is further performed by a computer being capable of multitasking, multithreading, multiprogramming or multiprocessing software execution.

8. The fuel dispenser control system of claim 7, wherein said functionality of each plurality of fuel dispenser control devices and said main control unit are performed by said computer being capable of multitasking, multithreading, multiprogramming or multiprocessing software execution.

9. The fuel dispenser control system of claim 1, wherein communication of said fuel dispenser control devices with said pump computers is independent from said main control unit.
